(19) United States
(12) Patent Application Publication
(10) Pub. No.: US 2018/0324937 A1
(43) Pub. Date: Nov. 8, 2018

(54) Shock wave nano-technology method

(71) Applicant: Baruch Boris Gutman, Far Rockaway, NY (US)

(72) Inventor: Baruch Boris Gutman, Far Rockaway, NY (US)

(21) Appl. No.: 15/731,237

(22) Filed: May 8, 2017

(51) Int. Cl. H05H 1/42; C23C 4/134; H05H 1/34; B05B 7/22

(52) U.S. Cl. CPC H05H 1/42; C23C 4/134; B82Y 30/00; B05B 7/226; H05H 1/34

(57) ABSTRACT

The patent described the advantages of detonation plasma spraying, laser pyrolysis technologies, etc., being optimized by pulses with common parameters, like duration, slope for all mentioned above technologies.

For example, in some high temperature processes, using pulsed plasma or laser technology, plays vital important role the efficiency of plasma chemical processes. Since the plasma chemical reaction process efficiency is ˜20-30%, its value could be increased up to the thermodynamically feasible level of 60%.

The Shock waves created by electrical pulses disintegrates liquid particles up to Nano size fragments, accelerate them and finally formatted a coating with superior characteristics.

The influence of the pulses of radiation, detonation, electro impulse plasma can be generated by the same single pulse parameters of duration, slope, etc.

### FIELD AND BACKGROUND OF THE INVENTION (SPECIFICATIONS)

The invention relates to shock wave Nano-technology method and particularly to pulse modulated plasma-laser-detonation technology of combination pulse plasma spraying materials, spraying materials with plasma detonation of hydrocarbons in air, pulse laser technology of chemical reaction in hydrocarbon mixture were elucidated in around 100 publications, Patents, etc. from 1970 year in USSR, USA, Central Asia, Israel:

https://www.linkedin.com/in/boris-yefimovich-gutman-%D0%B3%D1%83%D1%82%D0%BC%D0%B0%D0%BD-40aa8353/ or references No:1-14

There are several shortcomings of current materials spraying technology (low spraying efficiency, low tensile bond strength, uncontrol porosity, high operation cost, etc.), low hydrocarbon thermal reaction efficiency η if using the medium with oxygen-hydrocarbon mixture. The classical thermal chemical pyrolysis of hydrocarbons characterized by 2-3 times less η than thermodynamically possible 60%.

### I. Pulse Plasma Chemistry [1]

Use Air's and Hydrocarbons' mixture allows scientifically (up to 10 times) decrease expenditures for plasma forming gases in comparison with Helium and Argon what increasing an area of coating applications up to large dimensions' metal constructions.

Given the thermodynamic valuation of the carbon-hydrogen-sulfur (C—H—S system) in the case when C/H=1.2, the chemical reaction efficiency-n represented as a relation of enthalpy of the products of plasma pyrolysis like C₂H₂, C₂H₄ and C₃H₈ at standard temperature, to the enthalpy at temperature corresponding to the minimized energy expenditures would reach the value η=60%. Since in continuous plasma-chemical processes η<20-30%, its potential of increasing up to the thermodynamically feasible level has an unquestionable interest.

With this aim in view, neodymium solid-state laser NdP/sup 5/O/sup 14/, of averaged radiative energy per pulse equal to 5 J, operating in infrared range of wave length λ=1060 nm, power density So=10¹¹-10¹² W/m² and pulse length τ=10⁻²-10⁻⁴ s. The selected target material to perform laser pulse pyrolysis was petroleum resin of molecular mass 1,000 (C—82.1%, H—11.2%, S—3.5%, O—2%).

The pulse length was controlled by varying the inductance in the flash-discharge tube power circuit. To measure the radiative energy E involved in the reaction, and to determine η, a micro calorimeter (sensibility ˜0.5 μcal) was designed around a common operation amplifier. The laser chemical reactor fitted with the micro calorimeter was made up from comparative and experimental chambers. The resin was placed in the latter. To provide the containment of the chamber and minimize the losses in radiation, one of its walls was made of glass having an upper threshold of λ=2,700 nm. The chemical reaction time t of formation of C₂H_{2,} C₂H₄ was determined by solving chemical kinetics (L. Kassel scheme, USA, 1935) and hydrodynamics equations, considering the energy losses.

At the energy losses from 3 up to 11 kcal/mole and t>10⁻⁴ s, the C₂H₂ and C₂H₄ concentration reaches the thermodynamic equilibrium level. Since t<τ<tₚ (tₚ is the time required for the gas cloud expansion), then the thermodynamic equilibrium in this experiment can be ensured if t<tₚ.

Unsaturated hydrocarbons likely reacted with molecular oxygen emitted during “shock degassing” of resin by a detonation wave. Consider the power density of a laser radiation pulse, an approximate assessment of the products detonation velocity in the air can be calculated thus:

D=[2(γ²−1)So/ρₒ]^{1/3}=2.6 ·10³ m/s.

of enthalpy:

H=(2^{2/3}γ)(So/ρₒ)^{2/3}(γ²−1)^{1/3}(γ+1)=6.4·10⁶ J/kg,

and of a medium-mass temperature 3.4·10³ K (γ—adiabatic index; ρₒ—density). This assessment makes it possible to approach the problem in relation to the findings of thermodynamic calculations, and to determine the composition of shock degassing products.

The expanding cloud of gaseous products contains 0.5 mole fraction of dissociated hydrogen and 10⁻⁴ mol. fraction of dissociated nitrogen and oxygen, therefore of shock-induced expansion of the cloud involves the infrared radiation.

During expansion, the gaseous products temperature comes down, whereas t will rise (Arrhenius equation) to reach tₚ.

As soon as t=tₚ the need to arrange for the heat sink is excluded, therefore the stage of “hardening” the reaction products become redundant. This is vital important for plasma chemistry technology.

Now consider the experimentally obtained experimental data for η(τ), FIG. 1a and η(E), FIG. 1b.

Negative values of η in the oxygen medium can be accounted for by the additional heat emitted in the reactor owing to the oxidation process of reaction products.

Comparison the experimental data indicates the fact that η of pulse pyrolysis will be more responsive to energy—E than to pulse duration—τ and eventually is approximated to the thermodynamically feasible value of η˜60%, which is 2-3 times more than continuous plasma chemical pyrolysis.

### II. Disintegration Mechanisms [2, 3, 4, 5, 8, 9, 10, 11, 13, 14]

After experimentally justifying application hydrocarbons as plasma forming admixture should be considered plasma spraying technology by shock wave based on Air—Hydrocarbon mixture as plasma forming gas.

Per the method of it is necessary to assure that the plasma arc current pulses create high effective plasma shock waves, so that they will impart maximum acceleration and disintegrate spray particles. To do this, it is necessary that the electrical time constant of the plasma be minimized. Thus, plasma forming gases with great time constant (like Argon) apparently can't be applied for all range of currents, because it is impossible to create an effective shock wave.

Factors, which influence the choice of pulse parameters, include the derivative of the time constant curve at the point selected for the operating plasma arc current.

The melted particles being sprayed will be crushed by a high speed convective flow produced by a shock wave. In doing so, the initially spherical droplets take the shape of an ellipsoid of revolution whose greater axis is normal to the plasma jet direction.

The friction against a result in an adiabatic boundary layer which is formed at periphery of particle and is torn-off by a gas flow of shock wave nature, leading to an increase of a heat exchange between plasma and particle which is overheated and easy disintegrated at shock wave impact.

With the strength of the mechanisms underlying the droplets destruction because of impact perturbation, then depending on Weber numbers (We) and the time of destruction and velocity history data, it is evident that the disintegration is likely to involve as many as six mechanisms. According to the estimation, the present technology is dominated by the vibration and “sack like mechanisms” of disintegration in the Weber range; 10<We<50.

The disintegration process involves both mechanisms taking place concurrently.

Vibrations are developed on intrinsic frequencies. The flux of plasma following a shock wave will interact with a droplet, thereby increasing the vibration amplitude which in turn causes the disintegration of droplets into large-size fragments.

In case of the “sack-like” breakdown, a spherical droplet would be reshaped into an ellipsoidal, where latter being blown out into a growing sack to be disintegrated into larger and smaller droplets. The larger ones were formed due to fragmentation of the sack rim.

The stage of nascent, the growing sack of sprayed particle is pointed out in FIG. 2 below.

### III. Sprayed Materials Analyses and Coating Parameters [2, 3, 4, 5, 8, 9, 10, 11, 13, 14]

Experimental results for DC torch with .by air-propane vortex stabilizing. the arc by plasma forming gas and whole cylindrical anode (self-establish arc).

The Sutherland Viscosity Law shows that with rise temperature as result of plasma chemical pyrolysis of hydrocarbons and plasma air are going to increase dynamic viscosity. Resulting of it is transition of vortex arc stabilization of DC arc in spraying mode to laminar one.

With a view of providing an explanation to a decreased through gas permeability in the powder spraying technique based on the arc current modulation was examined how the pulses superimposed on a current would affect the size of the particles being sprayed.

Once, the initial material in the form of not sifted at FIG. 3 (sizes of particles are within 5-200 μm), of course NiTi powder of inter-metallic compound was entered the conversed air-propane plasma jet. The particles involved will start to disintegrate, aggregate, FIG. 4.

In the case of unmodulated spraying, after categorizing the particles according to their size, it was found that most particles are of size ˜25 μm, with the smallest being 3 μm and the biggest 40 μm.

In the case of applying the “subtraction” pattern pulse current modulation corresponding to. 2.7 kHz, pulse amplitude 600 A, pulse duration is τ=100 μs, arc voltage V=206 V, and arc current 135 A, there would emerge small particles along with bigger ones. Most of them are of 3 μm in size, their range being from 0.5 μm to 5 μm. Hence, it was concluded that the current pulses superimposed per “subtraction” pattern is bringing about an 8 to 10-fold decrease in the size of spheroidized particles, FIG. 5. When the modulation frequency was 2.7 kHz, the particles would interact with shock waves nine times within the period required for them to cover the distance from the DC torch to the substrate. Therefore, by increasing modulation frequency Vₘ, it is possible to get the particles size even smaller.

About the effect by the “adding” pattern pulse current modulation on the particles being sprayed at ΔI=0.8 kA, τ=200 μs and Vₘ=800 Hz, and ΔI=3.5 kA in next FIG. 6.

The conclusion is, therefore, that ΔI is the magnitude to determine the size of the spheroidized particles of the more numerous fractions, while the minimum and maximum size of the individual particles will be dependent on frequency modulation Vₘ—the higher vₘ, and the less are these sizes.

The through coating gas permeability θ=ΔP·S/ht, ([θ]=Pa˜m/s) was measured as a drop down a gas pressure through coating square—S, and thickness—h for unit of time—t. The decreased through gas permeability θ (FIG. 7) and increased tensile bond strength σ of coating with substrate (FIG. 8) accordingly, can be accounted for among other things, by the fact that the modulation gives rise to the formation of plasma coatings which is assembled from the fine particles (of 0.05 to 5 μm) moving with high velocity where α (Integral characteristic of processed powder, %) versus vₘ (FIG. 9.).

Comparing two curves was indicative of the fact that the maximum arc current corresponds to the maximum index at Vₘ=3.2 kHz. At this frequency, the shock waves of the modulation pulses can increase the amplitude of the arc channel transverse oscillations, there by intensifying the high level by-pass (HLB). As the arc gets shorted, will be demonstrated by the voltage, V, comes down from 206 to 170 V.

Apparently, the intensified scale of the HLB processes give rise to the diffusion of “hot” ions from the ionization zone to the dissociation zone where the powder is fed. Due to more intense heating of the powder, magnitude of it growing accordingly.

The use of the “adding” pattern pulse current modulation (FIG. 10) with the rise of ΔI from 0.3 to 3.5 kA, will display 6 to 8% increase, where versus ΔI in adding modulation (τ=200 μs)

In fact, when the spraying technique is performed in an adequate and orderly manner, the procedure will not be too sensitive to the initial size of the particles sprayed (sizes of the particles are within 5-200 μm while in traditional spraying technologies are within 10-60 μm).

### IV. Wire-Spraying Results [2, 3, 4, 5, 8, 9, 10, 11, 13, 14]

In our experiments, the anode length was 5·10⁻² m, the greatest length of the arc at current I=(2-4)10² A, while in the nitrogen plasma jet.

Just beneath the anode's end, normal to the plasma jet axis, a wire was fed into the core of jet.

In FIG. 11 one seen how the arc modulation following the “subtraction” (a) pattern or in the “adding” (b) pattern will affect the average diameter of the sprayed particle d.

In the modulation frequency interval under study, the length of a free arc always exceeds the anode length, which is indicative of the arc being virtually by-passed onto the wire.

### V. Control of Plasma Torch Parameters Vs, Modulation [2, 3, 4, 5, 8, 9, 10, 11, 13, 14]

At Vₘ=0.3 kHz, the particle diameter d and the arc length Lₐ (FIG. 12) will be the greatest at the minimized current I. The arc would stretch, forming loop, and then by-pass the wire being fed.

Since the arc spot was narrowed down, following the decrease in current amount of Joule heat flowing to the wire will be reduced. The first significant drop in a DC torch arc current takes place at the first resonance frequency of 300 Hz of three-phase power supply.

Hence the inadequate heating of the material sprayed, giving rise to the formation of large-size fractions of the particles. Apparently, at the same time the thermal mechanisms of the wire disintegration, as per “adding” and “subtraction” patterns, a ponderable contribution is performed by electron bombardment in the first commutation of the modulator with capacity in diagonal to the thyristor bridge.

Once the second commutation is started, the whole procedure is supplemented with the wire bombardment involving positive ions. Therefore, the disintegration based on the “subtraction” pattern is greater than the “adding” pattern. The shock-wave mechanism acts to speed up the disintegrated particles having the smallest d.

The general experimental results show (FIG. 13) the area of external change of V, I, La under 100μs≥τ_{sub}>25 μs under Δ/>1.66 and smooth character of change I and V at τ_{sub}<25 μs vs. frequency modulation. It is the way to control the DC plasma torch parameters

### VI. Spraying to a Water with and without Modulation by Torch with Non-Segmented Anode. Nano Particles Generations [2, 3, 4, 5, 8, 9, 10, 11, 13, 14]

AMDRY 6060 (powder of alumina Al₂O₃) powder was fed to the air-fuel plasma jet at the anode exit end of the torch at angle of 105°, with respect to the plasma flow.

The particles sprayed in water were dried and afterwards investigated by SEM (FIG. 14a and FIG. 14b).

The size distribution of particles when the spraying procedure is performed based on modulation as per “subtraction” pattern at vₘ=29 kHz below.

The left part of the distribution (with modulation) contains many small particles. To increase the number of the smallest particles, the specific enthalpy must be increased (FIG. 15a and FIG. 15b.).

### VII. Major Spraying Results and Testing “Shock Wave Nano-Technology of SDr. B. Gutman” by SULZER-METCO and PRAXAIR INC [8]

Testing of the modulation technology was done in the results of the first (97PE149A) and second phase of collaboration with SULZER METCO AG and PRAXAIR Inc. Parameters used: DC current was at 290 A, DC voltage was 250 V, plasma forming gas consumption was 60 liter/min, propane consumption was 4-6 liter/min, modulation frequency changed from +5 kHz up to −30 kHz, the deposition rate was 2-5 kg/hour, deposition efficiency was 80-95%, feed rate was 5-7 kg/hour (FIG. 16, 17)

Praxair's data shows that without a sub-layer, a magnitude of tensile bond strength between ceramic coatings (ALO-105, CRO-172, and ZRO) and stainless steel is within 11,000-13,000 psi.

### Porosity, Tensile Bond Strength and Contamination of Coatings. [2, 3, 4, 5, 8, 9, 10, 11, 13, 14]

By a variation of the enthalpy and modulation parameters for any type of DC arc torches, it is possible to control the particle's purity, size and consequently the quality of coatings (porosity, micro-hardness, tensile bond strength and so on) with deposition efficiency approaching to 100%.

The modulation technology is a very effective way to decrease contaminations contents in spraying materials, even with spraying by the medium with oxidation potential.

Praxair's testing data shows that without a sub-layer, a magnitude of tensile bond strength between ceramic coatings (ALO-105, CRO-172, and ZRO) and stainless steel is within 11,000-13,000 psi.

It was known (Technical report issues of Sulzer Metco AG) that DC arc modulation allows to perform a control over the coatings porosity from 0 up to 30%.

The results of the coatings testing of “Plasma Model Ltd” company received by pulse technology of Dr. B. Gutman (USA, ISRAEL, USSR Patents) performed by Praxair (Inc) and SULZER-METCO (Inc) were presented in the report 97PE149A. During the meeting, the execution of a second series of tests was decided and samples were delivered to SULZER-METCO (Inc) laboratory in city Wohlen of Switzerland: “THE PRESENT REPORT SHOWN THE IMPRESSING POTENTIAL OF THE TECHNOLOGY OF SDr. B. GUTMAN”.

Because of DC arc modulation, the shock wave interaction with the spraying particles brings about the shock degassing process, decreasing the content of the any contaminations like oxide-carbon-nitrogen {titanium oxide with carbon and nitrogen admixtures-TiO (C, N)} within 3-5 folds

### VIII. Detonation Phenomenon in DC Torch [3]

In DC torch, self-acceleration may not occur until the explosive concentrations of reagents are set up. For example, the limit for stationary explosibility in the case of propane and oxygen mix would amount to 3.2-37% by vol. If such a mix contains 30% of propane, then;

D=[(γ+1)/γ](8310 γT/μ)^{1/2}˜2.6·10³ m/s, where μ is the molecular mass of the product where γ-index of adiabat.

From equation D=[2Q_{det}(γ²−1)]^{1/2} we can find out the detonation heat Q det. then the detonation front pressure ΔP_{f}=2ρ(γ−1)Q_{det}˜2.8·10⁶ Pa.

At the temperature of T>1000° C. the detonation phenomenon started disappearing, while a shock wave was propagating in the plasma jet.

If the DC torch was designed properly with a self-establishing arc in a long (100 mm) anode channel at the expense of detonation,

It is possible to increase the bond strength of NiTi coatings with substrate from ˜50 MPa (7200 psi, without modulation) up to 200 MPa (˜29000 psi) because of the collision the particles accelerated by detonation waves.

Bond strength was measured by the pin method, because ASTMC-633-01 could not be applied.

### IX. Summary of Invention

The present invention is provided the method of “shock wave Nano-technology” allowing getting high effective plasma chemical reaction, the coatings with superior characteristics with assistance of shock waves created by laser pulses, detonation, pulses of current modulation.

The present invention shows the most important factor in creating effective shock wave technology is the slop of each pulse, which must be 10⁶ up to 10⁹ A/s.

The present invention shows that the next vital important factor for effective modulation is the “time constant” describing chemical nature of plasma regarding operation current.

The present invention shows that “time duration” is 10² μs for the C₂H₂ and C₂H₄ concentrations reaches the thermodynamic equilibrium level. The common “time duration” of pulse of different nature: laser-initiated_plasma chemical reaction, duration of detonation, pulses of current for spraying has the same order of magnitude 10² μs.

The present invention shows the method wherein the modulation technology is a very effective way to decrease contaminations contents in 2-3-fold in spraying materials, even with spraying in the medium with oxidation potential.

The present invention shows the method wherein the porosity of coatings can be control within 0 to 40%

The present invention shows the method wherein increasing enthalpy of plasma jet (for example from 10 kW/m³ up to 20 kW/m³) along with frequency modulation (for example from 0.2 kHz up to 30 kHz) convert plasma spraying torch operation to the regime of Nano particle generation up to size 0.1-5 nm.

The present invention shows the method wherein to set up in Plasma torch a mixture (air+20-35% of propane) at the expense of detonation, it is possible to increase the bond strength of coatings with substrate from ˜50 MPa (˜7200 psi, without modulation) up to 200 MPa (˜29000 psi).

The present invention shows the method wherein set up the duration of laser pulse infrared radiation, interacting with hydrocarbons, equal to the time 10⁻³-10⁻⁴s at which chemical reaction efficiency is achieved to theoretical feasible 60%.

The present invention shows the method wherein set up the velocity of electrons of arc close to the phase velocity of wave which is created by pulse modulator. These resonant electrons gain energy from the wave that lead to extend the length of the arc and is raising heat efficiency of the torch-η within 30-40%.

The present invention shows the method wherein to operate in the frequency range of 0.01-50 kHz of pulsed modulation, slope of each pulse must be 10⁶ -10⁹A/s.

The present invention shows the method wherein choose the plasma forming gas with suitable time constant, which is the characteristic of the nature of plasma forming gas and must be lower than 30 μs at the range of operation current to produce the effective shock waves.

The present invention shows the method where place of materials feeding for maximal disintegration must be in to the area of the where arc is attached to anode

The present invention shows the method 1 wherein at change of the frequency modulation find out the frequency at which minimal average arc current corresponds to maximal voltage V and length of the arc L.

The present invention shows the method wherein impose pulse with amplitude Δ at duration in range 100 μs≥τ_{sub}>25 μs under Δ/>1.66 which is necessary to control the length of DC arc and accordingly V-I characteristics of the torch.

The present invention shows that inserting hydrocarbons into the air plasma jet led to the transition of the plasma torch (with stabilization of DC arc by vortex) to the laminar spraying mode with a high coefficient use of powder

### DESCRIPTION OF THE PREFERRED EMBODIMENTS

The influence of the plasma/laser/detonation disturbances created by means of pulses of the different nature and the influence of these disturbances on above mentioned processes were subject of the present invention.

It is shown that inserting hydrocarbons into the air plasma jet is a contributing factor for the transition of the torch to the laminar spraying mode (with vortex stabilization of the arc), with a high coefficient use of powder. The physical estimations obtained have made understandable the mechanisms of the formation of the sprayed coatings. The results of interaction between the pulse-modulated plasma jet and the wire and powdery material being sprayed have been scrutinized in the given invention.

When plasma spraying is performed with DC current pulses superimposed in a reverse and direct polarity to the arc, the through-gas permeability of the coating is reduced by the order of magnitude. The most important explanation behind the phenomena is the disintegration of particles sprayed specific to the modulation process. By modulating the plasma arc current, sequential plasma shock waves disintegrate the spray particles, up to the size of the Nano-particles, and accelerate them toward the target substrate. The plasma arc current is precisely controlled to assure short “time constant” in the plasma, so that rapid changes in the plasma arc current form the plasma shock waves that strongly impact the spray particles.

The experimental data indicates the fact that η of pulse pyrolysis will be more responsive to energy-E than to pulse duration-τ and eventually is approximated to the thermodynamically feasible value of η˜60%, which is 2-3 times more than continuous plasma chemical pyrolysis.

The pulse modulated plasma jet initiate disintegration process of being sprayed powder, wire, etc. The flux of plasma following a shock wave will interact with a droplet, thereby increasing the vibration amplitude which in turn causes the disintegration of droplets into large-size fragments.

In case of the “sack-like” breakdown, a spherical droplet would be reshaped into an ellipsoidal, where latter being blown out into a growing sack to be disintegrated into larger and smaller droplets. The larger ones were formed due to fragmentation of the sack rim.

The decreased through gas permeability A and increased tensile bond strength a of coating with substrate accordingly, can be accounted for among other things, by the fact that the modulation gives rise to the formation of plasma coatings which is assembled from the fine particles (of 0.05 to 5 μm) moving with high velocity and penetrating deeply to crystal lattice of substrate.

The experimental results show the area of external change of V, I, La under 100 μs≥τ_{sub}≥25 μs under ΔI/I>1.66 and smooth character of change I and V at τ_{sub}<25 μs vs. frequency modulation. It is the way to control the DC plasma torch parameters.

It was shown that by a variation of the enthalpy and modulation parameters for any type of DC arc torches, it is possible to control the particle's purity, size and consequently the quality of coatings (porosity, micro-hardness, tensile bond strength and so on) with deposition efficiency approaching to 100%.

To increase the bond strength of NiTi coatings with substrate from ˜50 MPa (˜7200 psi, without modulation) up to 200 MPa (˜29000 psi) because of the collision the particle with the substrate by detonation waves.

While the invention has been described with respect to a limited number of embodiments, it will be appreciated that many variations, modifications and other applications of the invention may be made.

It was shown the effect of modulation of the plasma arc on the cutting process [12], greatly improves cutting characteristics, mainly because of an increase in length of the “free arc”, which in turn increasing cutting speed, thickness of cutting material.

### BRIEF DESCRIPTION OF DRAWING

FIG. 1a. The experimentally obtained experimental data for η(τ), η(E)

FIG. 1b. The experimentally obtained experimental data for η(E).

Experimentally found chemical reaction efficiency of resin pyrolysis vs. reaction temperature and energy of laser pulse radiation

FIG. 2. The stage of nascent, the growing sack of sprayed particle, formation stage of a growing sack of sprayed particle with thick rim.

It is shown, how is formed growing sack of sprayed particle during melting them in plasma jet spraying process

FIG. 3. Initial NiTi powder (size range is: 5-200 μm).

It is shown how looks like the powder before penetrating the plasma jet

FIG. 4. An example of powder aggregation

The melted particles may join each other

FIG. 5. Particle size distribution after plasma spraying with modulation as per “subtraction” pattern

It is shown, the experimental distribution of the particles vs. their sizes after spraying by DC plasma current with pulses opposite polarity to this current.

FIG. 6. Distribution of particles after spraying as per “adding pattern”: ΔI=0.8 kA

It is shown experimental distribution of the particles vs. their sizes after spraying by pulses of amplitude 0.8 kA of the same polarity to this current.

FIG. 7. The decreased through gas permeability θ vs frequency of modulation.

It was shown how the through gas permeability θ of coating depended on the frequency of modulation of DC arc.

FIG. 8. increased tensile bond strength σ of coating with substrate vs. frequency of modulation

Experimental data of dependence bond strength σ of coating with substrate vs. frequency of modulation

FIG. 9. α versus νₘ and I in subtraction modulation

Integral characteristic of processed by plasma of powder shown in dependence of current and frequency pulse modulated plasma in reverse polarity to the DC arc.

FIG. 10. α versus ΔI in adding modulation (τ=200 μs)

Integral characteristic of processed by plasma of powder shown in dependence of current and frequency pulse modulated plasma in direct polarity to the DC arc.

FIG. 11. Particle diameter versus modulation frequency (a—“subtraction” and b—“adding” pattern) for Ni, Stainless steel, Tungsten wires.

It is shown the sizes of sprayed particles in dependence of the types of modulation and for different materials like stainless steel, Tungsten, Nickel.

FIG. 12. Arc length vs. frequency of modulation

It was shown the dependence of the length of plasma arc in the anode channel of Plasma torch vs. the frequency of modulation

FIG. 13. The DC arc voltage V, current I versus νₘ at

τ_{sub}=20 μs (ΔI/I<1.66−B), τ_{sub}=70 μs (ΔI/I>1.66−A).

It is shown the change of DC plasma arc voltage and current, in dependence of modulation frequency and the duration of each pulse imposed onto the DC arc.

FIG. 14a. EM images of particles sprayed under the low modulation modes.

FIG. 14b. EM images of particles sprayed under the high modulation modes

At this image shown significant change fraction composition of sprayed materials in dependence of different types of modulation modes.

FIG. 15a(Upper). Generations of Nano-particles with modulation

FIG. 15b. Generations of Nano-particles without modulation

Comparison of the fraction composition of the sprayed materials in dependence of the enthalpy of DC plasma torch at the modulation and without.

FIG. 16. Microstructure of coating from Al₂O₃ sprayed without modulation: micro-hardness is ˜1066 HVO.3, porosity is 2.0%.

At this microstructure was shown that without modulation in coating revealed the significant porosity.

FIG. 17. Microstructure of coating from Al₂O₃ sprayed with modulation under frequency—20.5 kHz: micro-hardness is ˜1200 HVO.3, porosity is ˜0.5%

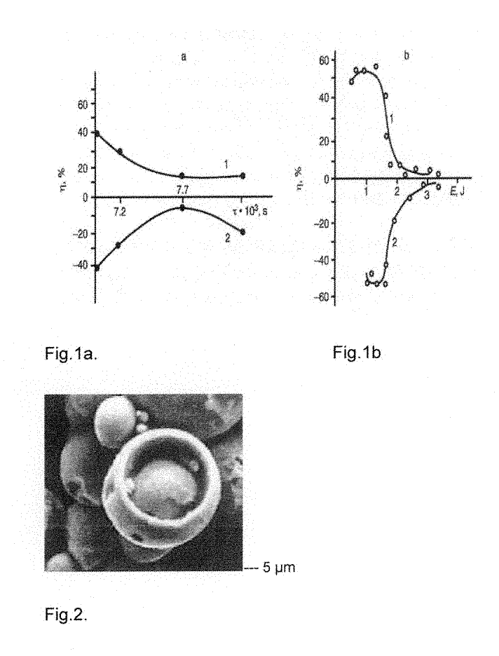

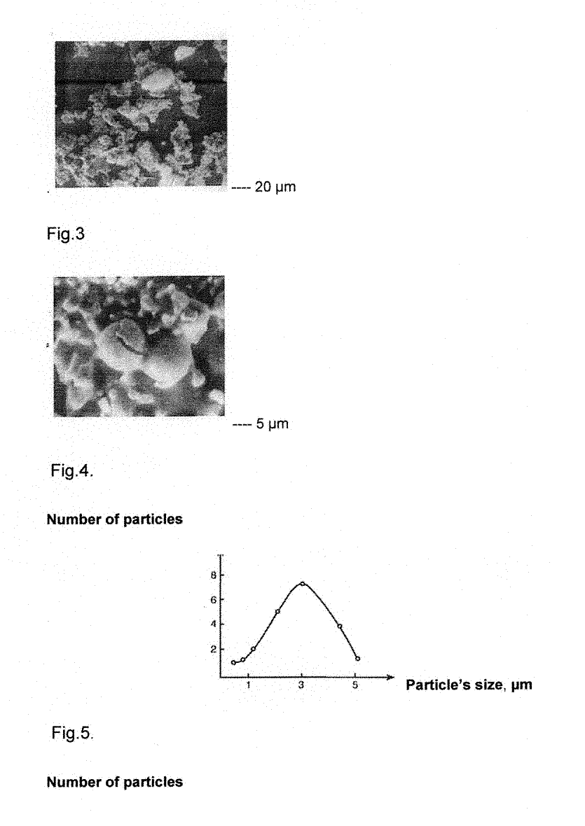

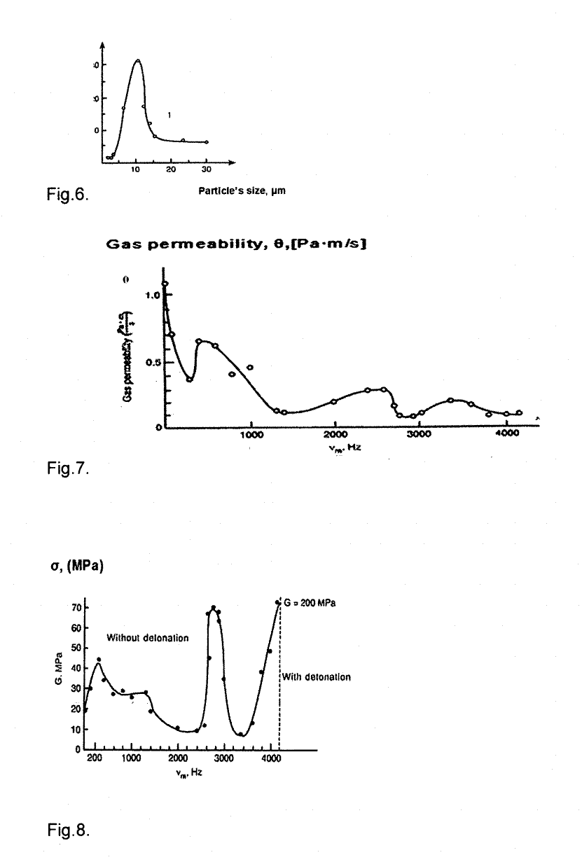

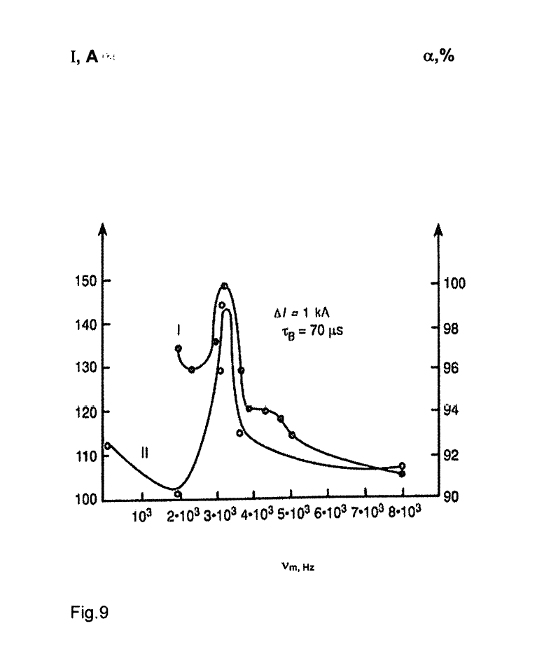

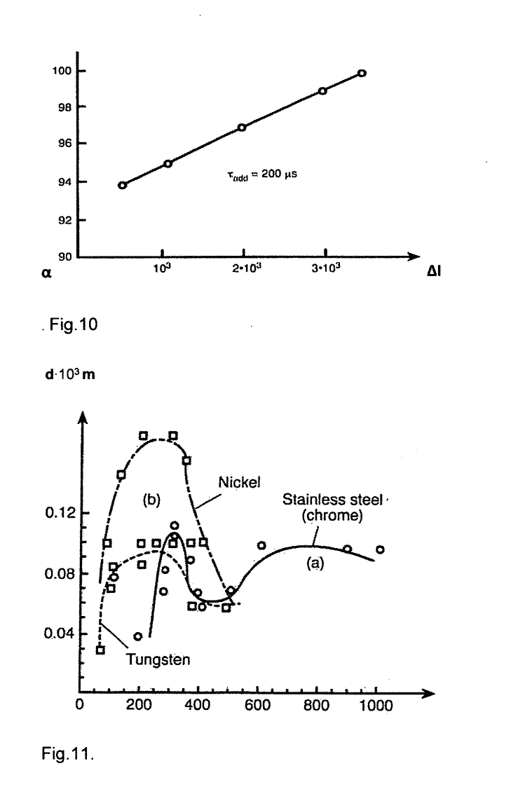

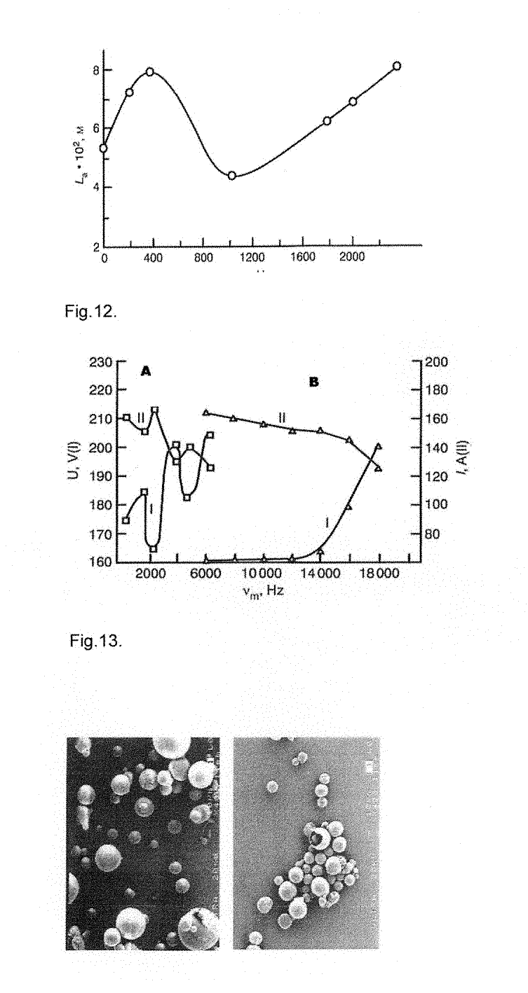

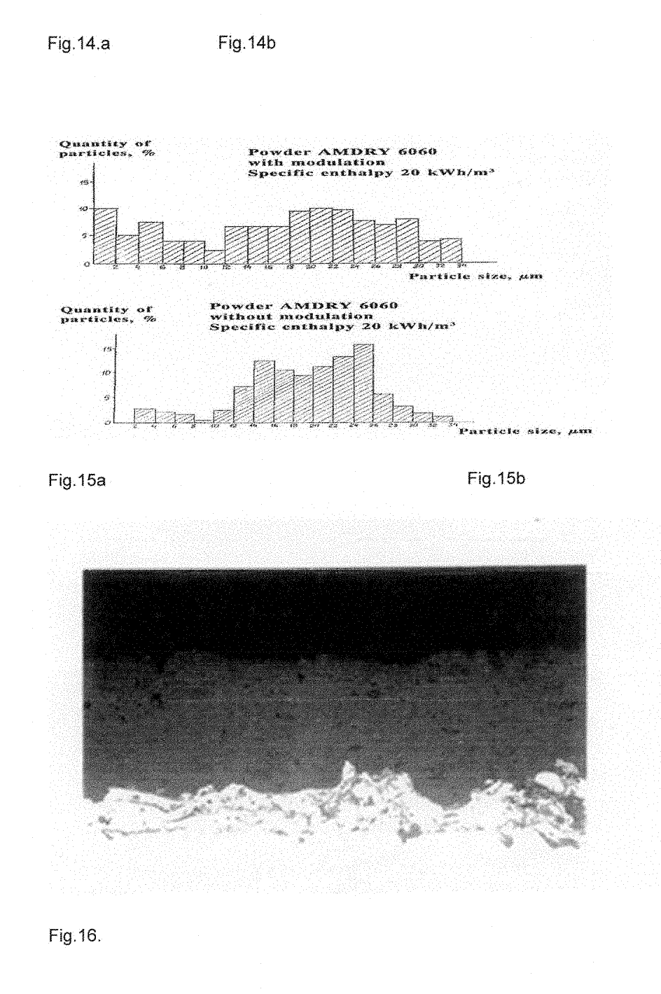

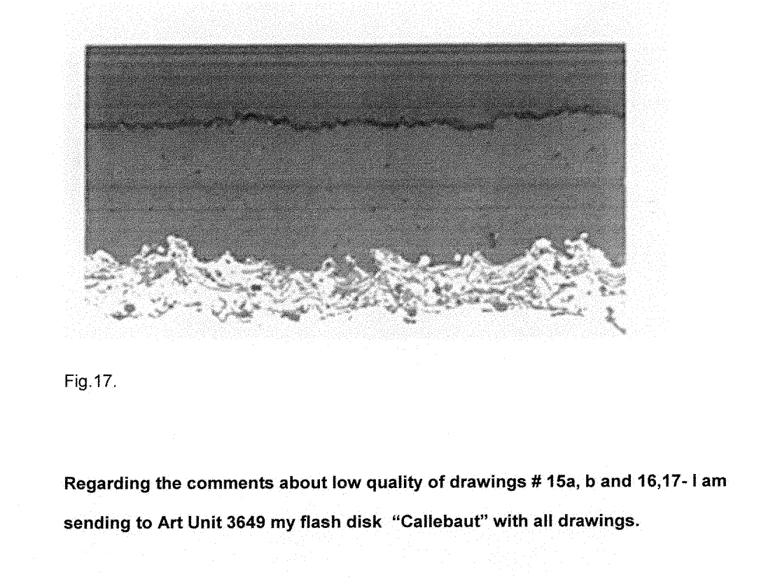

At this microstructure was shown that without modulation in coating the porosity. Is almost absent.

### REFERENCES (NEW)

1. B. E. Gutman,“ Shock degassing as a method for increasing process efficiency”, Fizika Goreniya i Vzryva, Vol. 25, No 2, pp 142-144, 198.
2. B. Gutman, “Shock wave atomization: physical mechanisms of a modulated DC Plasma torch during spray coatings”, “Atomization and Spraying”, Journal, Vol. 16, Issue 3, pp. 279-298, 2005.
3. Boris Gutman,“ Pulsed plasma and laser technologies and their business aspects”, Cambridge international Science publishing, England, ISBN 1898326967, pp. 203, September 2000. (book with all USSR's-Israel's Patent, Publications, up to 2000, translated to English, could be received from Author B. Gutman: boris.gutman@gmail.com).
4. B. Gutman-Goodman, “Plasma spraying Arc current Modulation method” U.S. Pat. No. 5,900,272, PCT/US98/22011, October 1997, May 1999.
5. B. Gutman, “Nano Plasma Technology Production for tiles against piercing weaponry”,
Open Materials Science Journal, 3, pp. 40-46, 2009.
6. B. Gutman, “Thermal nucleus fusion torch method”, U.S. Pat. No. 8,436,271, 2013.
7. B. Gutman, “Experimental base for Introduction to Non-magnetically Fusion engine development”, Journal of Electrical and Electronic Engineering”, 2017.
8. B. Gutman, “Testing Results of Plasma Spraying Ceramics Coatings by Pulse Plasma Modulation Technology”, American Journal of Nano Research and Applications, pp. 49-60, September 2017.
9. B. Gutman, “Mechanisms influencing on the parameters of plasma coatings in a modulated plasma arc”, Proceeding of ITSC, Kobe, May 1995.
10. B. Gutman-Goodman, “Shock wave physical mechanisms of modulated arc as applied to dusted plasma flows to form the coatings”, Proceedings of ITSC 2005, Basel, Switzerland
11. B. Gutman-Goodman, “The development of novel technologies for plasma spraying of coatings”, Proceedings of the 5^{th} national thermal spray conference, June 7—Anaheim, Calif., 1993.
12. B. E. Gutman, “Effect of modulation on the plasma arc on the cutting process”, Svar. proiz., No. 7, 1985 (Welding production, July 1985).
13. B. E. Gutman, “Effect of modulation of the plasma arc on spraying parameters”, Welding production, September 1984.
14. B. Goodman-Gutman,“ Investigation of dispersion processes of sprayed particles by means of torch modulation”, Proceedings of the 7^{th} national spray conference, Boston, Mass., 20-24 Jun. 1994.

What is claims being:

I. A method of increasing chemical reaction efficiency from 20-30% up to theoretical feasible 60% comprising the steps of: (a) set up duration of infrared laser radiation of a pulse of around 10⁻⁴ s (10² μs) and slop of the pulse 10⁶-10⁹ A/s; (b) set up a resin in a hermetical chamber with transparent wall which located along his pulse's shot; (c) is being measuring gas products because of interaction of a resin with the pulse to calculate Chemical reaction efficiency.

II. A method of increasing a bond strength of coatings with substrate in 4-5-fold comprising the steps of: (a) into a Plasma torch which is operated by Air is being inserting Hydrocarbons to create the detonation process; (b) set up the duration of detonation pulse is being around 10⁻⁴ s (10² μs) at the slop of a pulse's front is 10⁶-10⁹ A/s.

III. A method of producing a Nano-particles which is in turn formatting Nano coatings comprising the steps of; (a) igniting DC/AC plasma arc in plasma forming gas; (b) imposing on the plasma arc the pulses ΔI in direct/reverse or both polarity plasma current I; (c) set up the slope of the front of pulses 10⁶-10⁹ A/s at amplitude ΔI/I_{plasma current}≥4-5, duration of them for subtraction range is 10² μs≥τ25 μs, frequency range F_{modulation}≥20 kHz which is necessary to control length L_{arc} and accordingly V-I characteristics of DC/AC arc of plasma torch, generating a shock waves disintegration some liquid particles up to Nano size fragments and accelerating them.

IV. The method as define in claim I, II, III, the common “time duration of pulse of a different nature: laser initiated chemical reaction, detonation spraying process, pulses of current for spraying (claims #I, II, III) must be set up the same duration around 10² μs under slope of the pulses 10⁶-10⁶ A/s.

V. To exclude of oxygen from Air plasma and increase an enthalpy of plasma—should be inserting in the plasma a hydrocarbon which increase a coefficient of spraying efficiency and, in turn, convert the torch with a vorticial stabilization of an arc into high effective pseudo-laminar plasma.

VI. The point of material feeding in the torch must be in an area where a plasma arc is attached to the anode.

VII. The method as define in claim III to decrease nonmetallic contaminations (Me-metal, MeO, MeN, MeC) contents in 3-4-fold in spraying product.

VI. The method as define in claim III wherein to control a porosity of coatings in the range 0-40% should be variating the frequency of pulse modulation and an anode length within 60%.

VII. The method as define in claim III wherein to convert plasma spraying torch operation to the regime of Nano particles generation up to size 0.1-5 nm—should increase the enthalpy of plasma jet to disintegrate and accelerate them by shock waves created by pulse modulation.

VIII. The method as define in claim III wherein to change the L_{arc} relatively to the point of powder feeding for spraying which occur impact on parameters of spraying, torch characteristics, etc., should be set up a velocity arc's electrons close to the phase velocity of wave which is creating by pulse modulator: these resonant electrons gain energy from the wave that led to control the L_{arc} and moreover is raising heat efficiency of the torch up to 30%.

IX. The method as define in claim III wherein by changing the frequency modulation can be find the value corresponding to a minimal average current I vs. maximal voltage V and Larc.

X. The method as define in claim III wherein suitable time const of a type of plasma forming gas should be lower than 30 μs to create a high effective shock wave.

XI. The method as define in claim III wherein when the pulses are applied to an arc in the reverse polarity, the integral characteristic of disintegrating of the particles reaches 100% at frequency corresponding to the growth of large-scale shunting of the arc at the spraying wire-anode.

XII. The method as define in claim III wherein the minimum size of the sprayed particles is determined by a number of shock waves interacting with the particle during its flight.

XIII. The method as define in claim III; the use of current modulation makes the process of spraying less sensitive to the initial dimensions of a spraying particles than in traditional technology.

XIV. The method as define in claim III wherein a plasma deposition of coatings in a regime of superimposing current pulses in a reverse polarity to the arc leads to an increase in an adhesion of the coatings to the substrate up to the detonation level and reduces the gas permeability of the coatings by an order of magnitude.

XV. Plasma cutting speed can be increased by30% with rise of pulse amplitude in the direct polarity to the arc and upper limit of cutting speed is restricted by a cathode failure.
